(19) United States
(12) Patent Application Publication
(10) Pub. No.: US 2004/0093778 A1
(43) Pub. Date: May 20, 2004

(54) Electroluminescent sign

(76) Inventor: Farshid H. Asvadi, Lexington, KY (US)

Correspondence Address: FARSHID H. ASVADI, PO BOX 24886, LEXINGTON, KY, 40524, US

(21) Appl. No.: 10/712,719

(22) Filed: Nov. 13, 2003

Related U.S. Application Data
(60) Provisional application No. 60/426,250, filed on Nov. 13, 2002.

(51) Int. Cl. G09F 13/22

(52) U.S. Cl. 40/544

(57) ABSTRACT

Disclosed is a robust, flexible and versatile electroluminescent sign that is readily mobile.

### PRIORITY

Priority is claimed on the basis of provisional application No. 60/426,250, filed Nov. 13, 2002, which is hereby fully incorporated by reference in its entirety.

### STATEMENT REGARDING FEDERAL SPONSORSHIP

Not applicable

### FIELD OF THE INVENTION

The invention relates to an electroluminescent sign.

### BACKGROUND OF THE INVENTION

Various electroluminescent signs are known in the art: illustrative examples of electroluminescent signs are found in U.S. Pat. No. 5,005,306 to Kinstler and in U.S. Pat. No. 5,566,384 to Chien. However, certain aspects of each electroluminescent sign known in the art limit that sign's usefulness. The usefulness of any electroluminescent sign depends on the sign's robustness, flexibility, versatility, and mobility. It is accordingly an object of the invention to provide a robust, flexible and versatile electroluminescent sign that is readily mobile.

### BRIEF DESCRIPTION OF THE DRAWINGS

FIG. 1 is a perspective view of an embodiment in which a single cylindrical tube contains the battery or batteries and is in contact with a planar sheet of electroluminescent material that is disposed between parallel layers of laminate material.

FIG. 2 is a front view of the embodiment depicted in FIG.1.

FIG. 2A is a detailed view of a portion of what is depicted in FIG. 2.

FIG. 3 is a back view of the embodiment depicted in FIG. 1.

FIG. 4 is a top view of the embodiment depicted in FIG.1.

FIG. 5 is a bottom view of the embodiment depicted in FIG.1.

FIG. 6 is a left view of the embodiment depicted in FIG.1.

FIG. 7 is a right view of the embodiment depicted in FIG.1.

FIG. 8 is a perspective view of an embodiment in which two cylindrical tubes contain the batteries and are in contact with a planar sheet of electroluminescent material that is disposed between parallel layers of laminate material.

### DESCRIPTION OF THE INVENTION

The invention provides a robust, flexible and versatile electroluminescent sign that is readily mobile.

The invention relates to a flexible, lightweight fully portable, rechargeable but robust sign that is easily visible under conditions of reduced ambient lighting.

In an embodiment, a sheet of electroluminescent (EL) material was sandwiched between two layers of laminate, the electroluminescent material being subject to excitement by an AC current. Two electrical conductors were placed in contact with the EL sheet but not in contact with one another. An inversion circuit board (providing for output of AC current from input of DC current) was placed in contact with the two conductors by contacting a spring connected to one terminal of the circuit board with one of the conductors, and a spring connected to the other terminal of the circuit board with the other of the conductors. Via a lead conductive when a switch is open, the inversion circuit board was placed in contact with two batteries. Hence, when the switch was open, DC current flowed from the batteries to the circuit board, which produced an AC current (and hence luminescence) in the EL material to which the circuit board was connected via the springs and the conductors.

In another embodiment, some of the switching was done electronically in order to obtain a mode of display in which the image was flashing. This however was done when the circuit was closed and current was flowing into the inversion circuitry.

In an aspect of the invention, a battery or batteries, serving as power supply to supply power to the inversion circuit, were housed in one or two tubes accommodating the batteries. The tube or tubes were secured in place by means of an adhesive and screws embedded in the body of battery holders within the tube or tubes. The driving circuit for the EL material was also housed within the tube or tubes.

A sign according to the invention is readily mobile, permitting the sign to be used in a vast variety of applications: as a handheld sign; as a promotional display sign (e.g. used in exhibitions); as a domestic sign (e.g. Christmas or Halloween sign); on a storefront; as a warning sign; as a pizza delivery vehicle sign or a taxi sign; as an underwater messaging or display sign for marine use, such as by divers. A sign according to the invention can be rolled up, enabling it to be used as a lantern while at the same time providing storage ability inside a tube. A sign according to the invention, when such a sign comprises a battery or batteries, is rechargeable.

One of many advantages that a sign according to the invention possesses over related art is that such a sign is not restricted in use. That is, in an embodiment, a sign according to the invention does not require a bulky frame or prolonged attachment to a surface, but rather has the inherent capacity to be flexible, thus enabling a sign according to the invention to be carried by itself or to be attached reliably to a non-flat surface. Another advantage over related art is that, in an embodiment, a sign according to the invention is immersible and waterproof, permitting such a sign to be used in a wider variety of conditions than signs known in the art. A further advantage that the invention possesses over related art is that, in an embodiment, a sign according to the invention is relatively lightweight. The invention thus satisfies a long-felt need for a lightweight, waterproof, fully mobile and versatile, readily illuminated sign.

In an example of an embodiment the invention (see FIG. 8), a planar sheet of EL material was placed between two planar sheets of laminate. The three sheets, running in parallel, as a sandwich, were affixed to and suspended between two right cylindrical tubes. Within the cylindrical tubes were battery holders and voltage inversion circuitry. The sheets were secured in place by means of an adhesive & screws and silicone applied to the body of the battery holders. In an especially preferred means of securing the sheets, mastic tape and silicone were used. These tubes were then sealed using a male screw-in cap at both end of the tubes with an O-ring washer placed on the cap to securely seal the tubes against moisture and other elements, making this sign 100% portable & waterproof. A switch was placed underneath a rubber membrane at the end of the tube. Voltage was induced to luminescence by means of current transmitted through two conductors connected to the EL at the end of the tube by means of small springs mounted on the inversion circuit connecting the EL terminals to the output of the circuit board, allowing current to flow to the EL material.

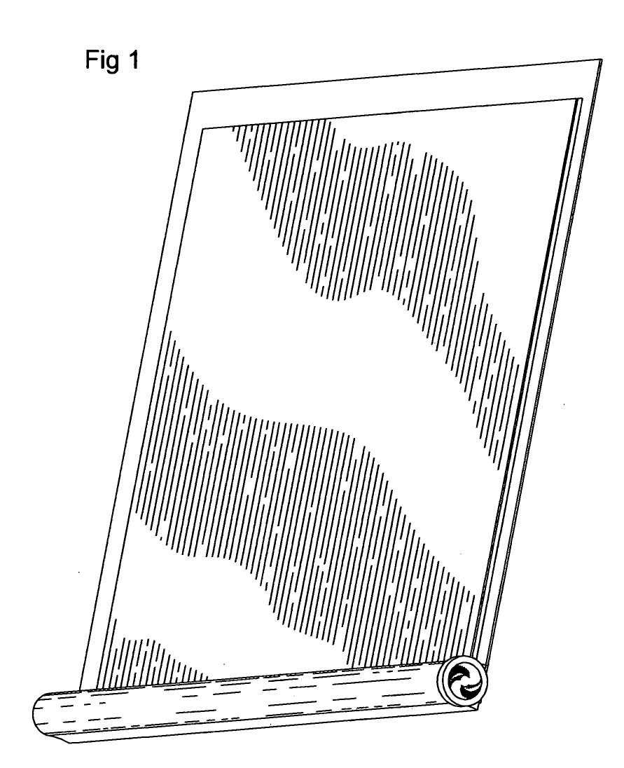

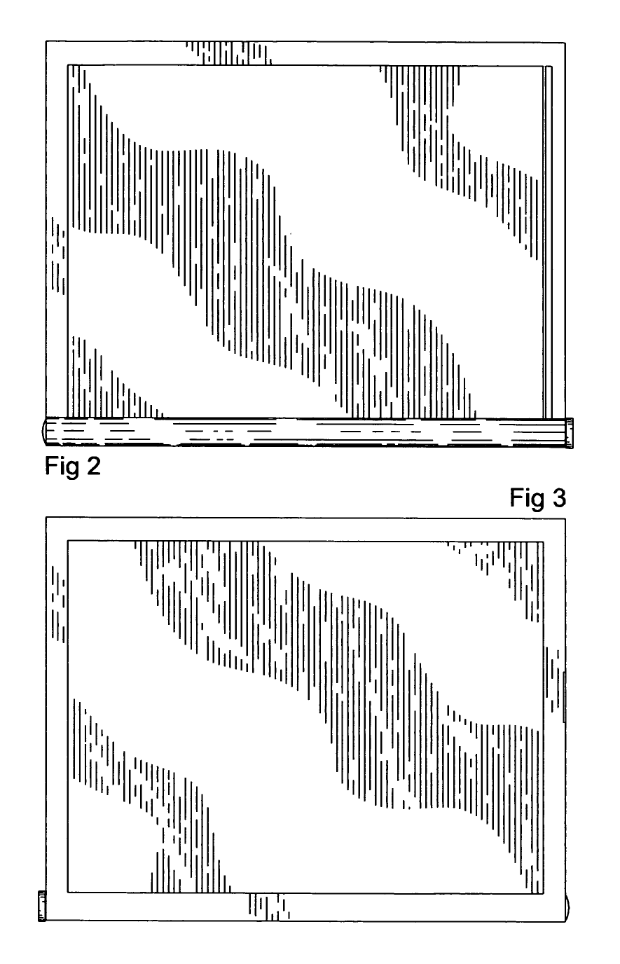

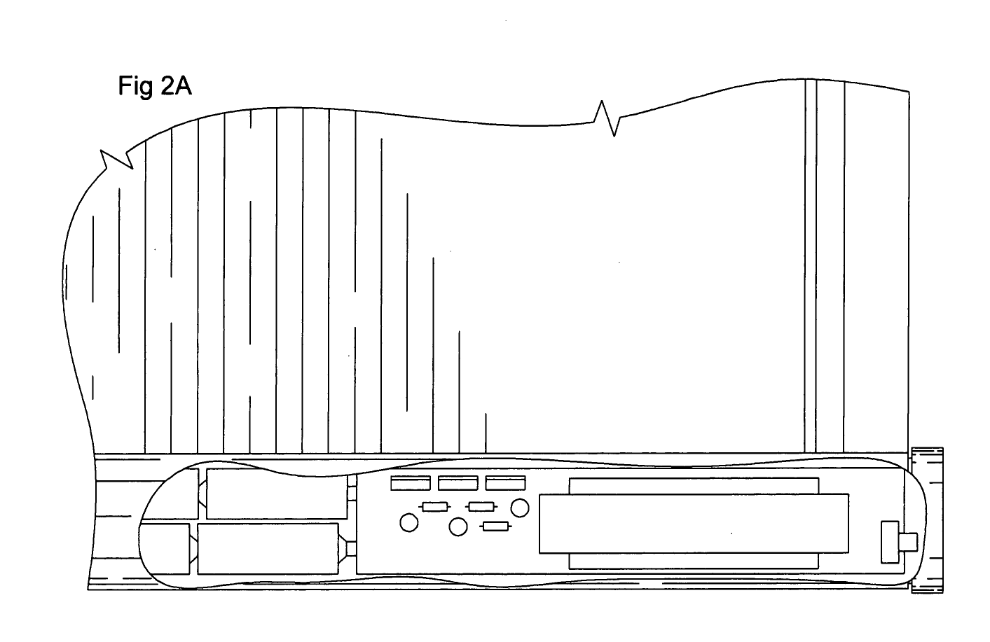

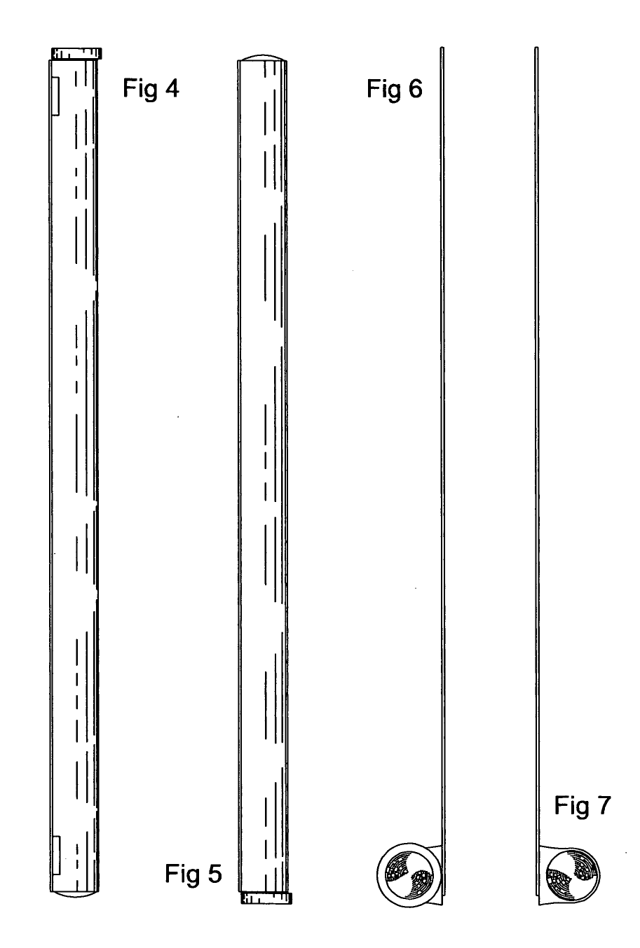

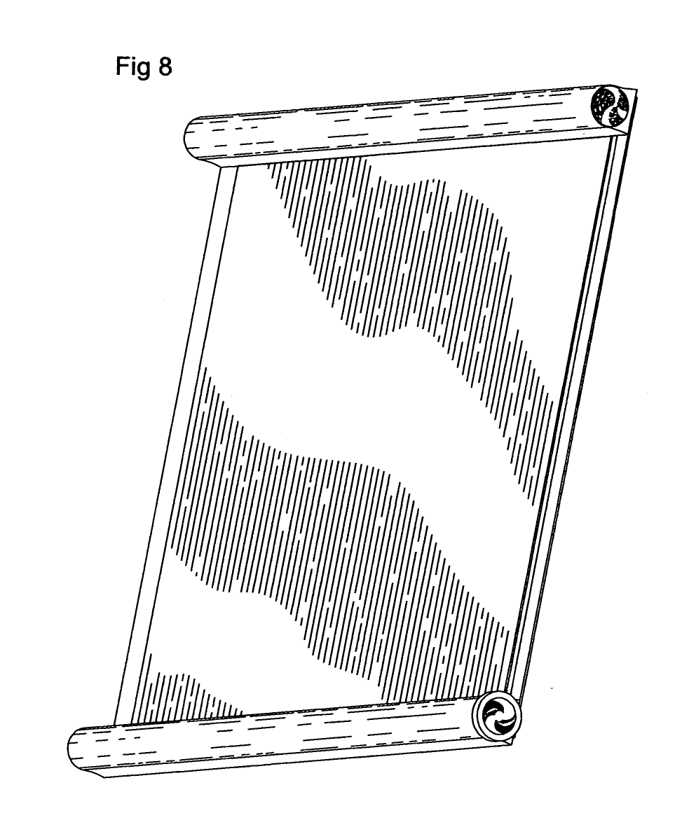

In another example of an embodiment of the invention, the sheets, running in parallel, were suspended from and affixed to one tube, rather than two tubes (see FIGS. 1-7); the circuitry and mechanical aspects were otherwise similar to those of the previous example.

By way of example of the utility of such an embodiment, electroluminescent material was cut into distinctive patterns recognizable as a graphic associated as a trademark with the goods or services provided by a commercial entity, viz., a well-known and prominent food delivery company. Those viewing the material under conditions of reduced ambient lighting recognized the logo of the company and later recounted the impression made upon them when they first viewed the logo of the company displayed and illuminated in this embodiment of the invention. This was introduced to a local branch of the aforementioned company where the potential uses as a store window display or a vehicle sign were demonstrated.

In an aspect of the invention, an embodiment of the invention remained illuminated even when the sandwich of sheets was rolled up into the shape of as scroll. In an aspect of the invention, an embodiment of the invention was found to be immersible and waterproof. In an aspect of the invention, a plurality of sheets of laminate material formed a clear pouch into which custom artwork was inserted for display against a luminescent background. In an aspect of the invention, a tube to which the sandwich of sheets was affixed served also as a handle for display of the image to be displayed.

In a particularly preferred embodiment, a sign according to the invention comprises a right cylindrical tube with which a planar sheet of electroluminescent material is contacted. At one end of the longitudinal axis of the tube, the sheet of electroluminescent material is contacted with each of two contact fingers protruding from an inversion circuit board housed within the tube. Each end of the tube is sealed by a screw cap in which an O-ring is seated. On a surface of the electroluminescent material not directly in contact with the contact fingers is applied silicone. This embodiment has a particularly favorable property of being waterproof and immersible.

Accordingly, the invention provides an electroluminescent sign for vehicular or non-vehicular display of a textual, graphic, mixed, or other image, comprising: a sheet of electroluminescent material; a laminate material, between layers of which the sheet is disposed; an inversion circuit, for excitation of the sheet and illumination of the image; and a power supply, for supply of power to the inversion circuit; wherein, while excitation of the sheet is ongoing, the sheet and the laminate material are susceptible of being rolled up into the shape of a scroll.

Accordingly, the invention additionally provides an immersible and waterproof electroluminescent sign for vehicular or non-vehicular display of a textual, graphic, mixed, or other image, comprising: a sheet of electroluminescent material; a laminate material, between layers of which the sheet is disposed; an inversion circuit, for excitation of the sheet and illumination of the image; and a power supply, for supply of power to the inversion circuit.

In an additionally preferred embodiment, the laminate material is transparent or translucent, and layers of the laminate material comprise a “pouch” of two or more adjacent layers of the laminate material that are parallel to the sheet of electroluminescent material. In the pouch is placed a graphic that is illuminated, for example, indirectly, by the electroluminescent material.

The foregoing description and embodiments are merely exemplary and are not intended to limit the scope of the invention, which encompasses all equivalents to what is described herein. Because one skilled in art will recognize obvious equivalents to the invention as described in this application, the invention itself relates to embodiments beyond what is disclosed verbatim and encompasses the entire range of equivalents to what is described above, which is by way of example only. Therefore only the principles of law and of equity limit the full scope to be accorded the following claims.

I claim:

1. An electroluminescent sign for vehicular or non-vehicular display of a textual, graphic, mixed, or other image, comprising:
a sheet of electroluminescent material;
a laminate material, between layers of which the sheet is disposed;
an inversion circuit, for excitation of the sheet and illumination of the image;
and a power supply, for supply of power to the inversion circuit.

2. An electroluminescent sign for vehicular or non-vehicular display of a textual, graphic, mixed, or other image, comprising:
a sheet of electroluminescent material;
a laminate material, between layers of which the sheet is disposed;
an inversion circuit, for excitation of the sheet and illumination of the image;
and a power supply, for supply of power to the inversion circuit;
wherein, while excitation of the sheet is ongoing, the sheet and the laminate material are susceptible of being rolled up into the shape of a scroll.

3. An immersible and waterproof electroluminescent sign for vehicular or non-vehicular display of a textual, graphic, mixed, or other image, comprising:
a sheet of electroluminescent material;
a laminate material, between layers of which the sheet is disposed;
an inversion circuit, for excitation of the sheet and illumination of the image;
and a power supply, for supply of power to the inversion circuit.

4. A sign according to claim 1, wherein the power supply comprises a battery.

5. A sign according to claim 2, wherein the power supply comprises a battery.

6. A sign according to claim 3, wherein the power supply comprises a battery.

7. A sign according to claim 1 further comprising a right cylinder that contains the power supply.

8. A sign according to claim 2 further comprising a right cylinder that contains the power supply.

9. A sign according to claim 3 further comprising a right cylinder that contains the power supply.

10. A sign according to claim 7, wherein the right cylinder contains the inversion circuit.

11. A sign according to claim 8, wherein the right cylinder contains the inversion circuit.

12. A sign according to claim 9, wherein the right cylinder contains the inversion circuit.

13. A sign according to claim 1, wherein the electroluminescent material is able to be formed or cut to assume a distinctive pattern that is recognizable as a graphic associated as a trademark with the goods or services provided by a commercial entity.

14. A sign according to claim 2, wherein the electroluminescent material is able to be formed or cut to assume a distinctive pattern that is recognizable as a graphic associated as a trademark with the goods or services provided by a commercial entity.

15. A sign according to claim 3, wherein the electroluminescent material is able to be formed or cut to assume a distinctive pattern that is recognizable as a graphic associated as a trademark with the goods or services provided by a commercial entity.

16. A sign according to claim 1, wherein the layers of laminate material comprise a pouch.

17. A sign according to claim 2, wherein the layers of laminate material comprise a pouch.

18. A sign according to claim 3, wherein the layers of laminate material comprise a pouch.

19. A sign according to claim 16, wherein the laminate material is transparent.

20. A sign according to claim 16, wherein the laminate material is translucent.
